(19) United States
(12) Patent Application Publication
(10) Pub. No.: US 2014/0111733 A1
(43) Pub. Date: Apr. 24, 2014

(54) BACKLIGHT MODULE AND LIQUID CRYSTAL DISPLAY DEVICE COMPRISING SAME

(71) Applicants: Jiaqiang Wang, Shenzhen City (CN); Shihhsiang Chen, Shenzhen City (CN)

(72) Inventors: Jiaqiang Wang, Shenzhen City (CN); Shihhsiang Chen, Shenzhen City (CN)

(73) Assignee: Shenzhen China Star Optoelectronics Technology Co., Shenzhen (CN)

(21) Appl. No.: 13/806,990

(22) PCT Filed: Oct. 31, 2012
(86) PCT No.: PCT/CN12/83869

§ 371 Date: Dec. 26, 2012

(30) Foreign Application Priority Data
Oct. 18, 2012 (CN) 201210397109.4

(51) Int. Cl. G02F 1/1335; F21V 8/00

(52) U.S. Cl. CPC G02F 1/133608; G02B 6/0083
USPC 349/58; 362/607; 362/631

(57) ABSTRACT

The present invention discloses a backlight module, which includes a light source, a PCB, and a backplane. The PCB forms a bend. The light source is fixed on the PCB that has the bend. The PCB is fixedly connected to the backplane to conduct away heat generated by the light source. The present invention also discloses a liquid crystal display device that includes the above structure of backlight module. Practicing the backlight module and the liquid crystal display device of the present invention enables optimization of a heat dissipation path within the backlight module to achieve ultra-slimming of side frame of the backlight module.

### CROSS REFERENCE TO RELATED APPLICATIONS

This application claims priority to Chinese Patent Application No. 201210397109.4 filed on Oct. 18, 2012, entitled “BACKLIGHT MODULE AND LIQUID CRYSTAL DISPLAY DEVICE COMPRISING SAME”, the disclosure of which is incorporated herein by reference in their entirety.

### BACKGROUND OF THE INVENTION

1. Field of the Invention

The present invention relates to the filed of liquid crystal display, and more particularly to a backlight module and a liquid crystal display device.

2. Description of the Related Art

A liquid crystal display device comprises a display module. To display an image, the display module needs backlighting to provide a light source. Existing backlights include CCFL (Cold Cathode Fluorescent Lamp) and LED (Light-Emitting diode). Being a novel light source, the LED shows advantages of high brightness and low power consumption. Thus, designs that incorporate the LED backlight are getting prevailing and are the trend of future designs. However, LEDs also produce a large amount of heat. To ensure the light emergence efficiency and life span of the LEDs, a heat dissipation arrangement is necessary for the LEDs.

Known backlight modules usually comprise LEDs packaged on a printed circuit board (PCB) or a metal core PCB (MCPCB) to form a light bar, which is then fixed on an aluminum extrusion by adhesive tapes or screws. The aluminum extrusion is then mounted to a backplane. The present inventor noted that a backlight module of such a structure does not meet the requirements for frame slimming of backlight module.

### SUMMARY OF THE INVENTION

The technical issue to be addressed in this invention is to provide a backlight module and a liquid crystal display device, which enable optimization of a heat dissipation path within the backlight module to achieve ultra slimming of a side frame of the backlight module.

To solve the above technical issues, a technical solution adopted in the present invention is to provide a backlight module, which comprises a light source, a PCB and a backplane, wherein the PCB comprises a bend and the light source is fixed on the PCB that has the bend, the PCB being fixedly connected to the backplane to conduct away heat generated by the light source;

the PCB comprising a horizontal plate and a vertical plate perpendicularly connected to each other, the light source being set at an inner side of the vertical plate, the backplane being mounted at an inner side of the horizontal plate; and

the backlight module further comprising a plastic frame, the plastic frame mounted to the PCB that has the bend and an optical component of the backlight module to hold the optical component down on the backplane, the optical component at least comprising a diffusion plate, a prism, a diffusion plate, and a light guide plate.

Wherein, the backlight module further comprises a front frame, the front frame comprising a front frame horizontal plate and a front frame vertical plate that are perpendicular to each other, the front frame horizontal plate pressing the liquid crystal glass against the plastic frame;

the front frame vertical plate being mounted at an outer side of the vertical plate of the PCB.

To solve the above technical issues, another technical solution adopted in the present invention is to provide a backlight module, which comprises a light source, a PCB and a backplane, wherein the PCB comprises a bend and the light source is fixed on the PCB that has the bend, the PCB being fixedly connected to the backplane to conduct away heat generated by the light source.

Wherein, the PCB comprises a horizontal plate and a vertical plate perpendicularly connected to each other;

the light source being set at an inner side of the vertical plate, the backplane being mounted at an inner side or an outer side of the horizontal plate.

Wherein, the backlight module further comprises a plastic frame, the plastic frame mounted to the PCB that has the bend and an optical component of the backlight module to hold the optical component down on the backplane.

Wherein, the plastic frame comprises at least a hold-down block, the hold-down block having a side forming two pressing surfaces, of which one pressing surface presses down an end face of the vertical plate and the other pressing surface presses down an end portion of the optical component that is close to the light source.

Wherein, the hold-down block has a side that is opposite to the side of the hold-down block that forms the pressing surfaces and is set to tightly engage the liquid crystal glass of the backlight module.

Wherein, one end side of the hold-down block is bended to form a frame plate, the frame plate being mounted at an outer side of the vertical plate of the PCB.

Wherein, the backlight module further comprises a front frame, the front frame comprising a front frame horizontal plate and a front frame vertical plate that are perpendicular to each other, the front frame horizontal plate pressing the liquid crystal glass against the plastic frame;

the front frame vertical plate being mounted at an outer side of the frame plate.

Wherein, wherein the backlight module further comprises a front frame, the front frame comprising a front frame horizontal plate and a front frame vertical plate that are perpendicular to each other, the front frame horizontal plate pressing the liquid crystal glass against the plastic frame;

the front frame vertical plate being mounted at an outer side of the vertical plate of the PCB.

Wherein, the hold-down block and the front frame vertical plate are integrally formed together to form a unitary body.

To solve the above technical issues, a further technical solution adopted in the present invention is to provide a liquid crystal display device. The liquid crystal display device comprises a backlight module, wherein the backlight module comprises a light source, a PCB and a backplane, wherein the PCB comprises a bend and the light source is fixed on the PCB that has the bend, the PCB being fixedly connected to the backplane to conduct away heat generated by the light source.

Wherein, the PCB comprises a horizontal plate and a vertical plate perpendicularly connected to each other;

the light source being set at an inner side of the vertical plate, the backplane being mounted at an inner side or an outer side of the horizontal plate.

Wherein, the backlight module further comprises a plastic frame, the plastic frame mounted to the PCB that has the bend and an optical component of the backlight module to hold the optical component down on the backplane.

Wherein, the plastic frame comprises at least a hold-down block, the hold-down block having a side forming two pressing surfaces, of which one pressing surface presses down an end face of the vertical plate and the other pressing surface presses down an end portion of the optical component that is close to the light source.

Wherein, the hold-down block has a side that is opposite to the side of the hold-down block that forms the pressing surfaces and is set to tightly engage the liquid crystal glass of the backlight module.

Wherein, one end side of the hold-down block is bended to form a frame plate, the frame plate being mounted at an outer side of the vertical plate of the PCB.

Wherein, the backlight module further comprises a front frame, the front frame comprising a front frame horizontal plate and a front frame vertical plate that are perpendicular to each other, the front frame horizontal plate pressing the liquid crystal glass against the plastic frame;

the front frame vertical plate being mounted at an outer side of the frame plate.

Wherein, the backlight module further comprises a front frame, the front frame comprising a front frame horizontal plate and a front frame vertical plate that are perpendicular to each other, the front frame horizontal plate pressing the liquid crystal glass against the plastic frame;

the front frame vertical plate being mounted at an outer side of the vertical plate of the PCB.

Wherein, the hold-down block and the front frame vertical plate are integrally formed together to form a unitary body.

The backlight module and the liquid display device provided in the present invention have the following beneficial effects. Since the PCB of the backlight module forms a bend, heat generated by the light source can be conducted through the PCB that has the bend and the backplane so as to effect dissipation of heat. This saves a step of assembling the PCB and the heat dissipation device and also saves material and also improves assembling efficiency and reduces the working costs. The thermal path within the module can be optimized to effectively reduce the internal architecture of the backlight module to achieve the design of ultra-slim module side frame increase a viewing area.

### BRIEF DESCRIPTION OF THE DRAWINGS

To more clearly explain the technical solutions of embodiments of the present invention or those of the existing techniques, a brief description will be given to the accompanying drawings that are necessary for the illustration of the embodiments or the existing techniques. Apparently, the drawings described below show only example embodiments of the present invention and for those having ordinary skills in the art, other drawings may be easily obtained from these drawings without paying any creative effort. In the drawings:

FIG. 1 is a schematic view showing a cross-section of a backlight module according to a first embodiment of the present invention; and

FIG. 2 is a schematic view showing a cross-section of a backlight module according to a second embodiment of the present invention.

### DETAILED DESCRIPTION OF THE PREFERRED EMBODIMENTS

A description of preferred embodiments of the present invention will be given below with reference to the attached drawings.

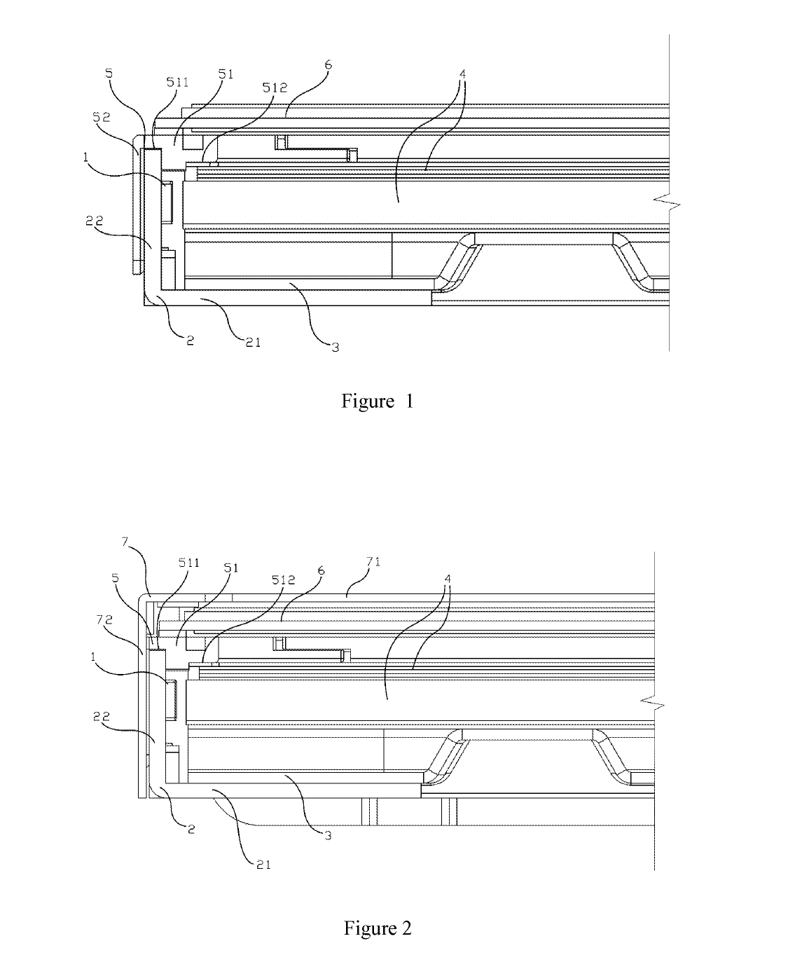

As shown in FIG. 1, a backlight module according to the instant embodiment comprises a light source 1, a printed circuit board (PCB) 2, a backplane 3, an optical component 4, a plastic frame 5, and liquid crystal glass 6.

The PCB 2 has a bend. The light source 1 is mounted to the PCB 2 that has the bend. The PCB 2 and the backplane 3 are fixedly connected.

The plastic frame 5 is fixed to both the PCB 2 that has the bend and the optical component 4 so as to position the optic component 4 tightly against the backplane 3. The liquid crystal glass 6 is fastened by the plastic frame 5.

The light source 1 comprises a structure that adopts LEDs or an LED light bar that is packaged in an inner side of the PCB 2 that has the bend.

The PCB 2 comprises a horizontal plate 21 and a vertical plate 22 that are connected to each other. The horizontal plate 21 is a plate mounted to the rear side of the backlight module and substantially parallel with the backplane 3. The vertical plate 22 is a plate set in the area of a side frame of the backlight module. In one embodiment, the horizontal plate 21 and the vertical plate 22 are perpendicular to each other.

Furthermore, the LED light source is fixed to a middle portion of the inner side of the vertical plate 22. The backplane 3 is mounted to the inner side of the horizontal plate 21.

The PCB 2 can alternatively be an MCPCB without affecting the practice of the instant embodiment.

An enclosed area delimited among the above mentioned horizontal plate 21, vertical plate 22, and backplane 3 can be used to receive the optical component 4. In the instant embodiment, the optical component 4 is set at a light emitting side of the light source 1. As shown, the optical component 4 comprises various components which are at least, from top to bottom, a diffusion plate, a prism, a diffusion plate, and a light guide plate.

The plastic frame 5 is mounted on the PCB 2 that has the bend and the optical component 4 of the backlight module to tightly press the optical component 4 against the backplane 3.

Specifically, the plastic frame 5 comprises a hold-down block 51 and a frame plate 52 that is bent to locate at one end side of the hold-down block 51. The hold-down block 51 and the frame plate 52 form a space therebetween to fit over the vertical plate 22 so as to have the PCB 2 that has the bend tightly fixed on the plastic frame 5.

Furthermore, a shown, the hold-down block 51 has a bottom forming two pressing surfaces, of which one pressing surface 511 presses down an end face of the vertical plate 22 and the other pressing surface 512 presses down an end portion of the optical component 4 that is close to the light source 1.

As shown, the hold-down block 51 has a top that forms a flat surface tightly engaging the liquid crystal glass 6.

The frame plate 52 is connected to the end side of the hold-down block 51 with the vertical plate 22 of the PCB being held therebetween. The frame plate 52 is a plate that is set in an area of the side frame of the backlight module. In the instant embodiment, the frame plate 52 is fastened on an outer side of the vertical 22 of the PCB.

As shown in FIG. 2, a schematic view is given to show a cross-section of a backlight module according to a second embodiment.

The instant embodiment is different from the previous embodiment in that the backlight module further comprises a front frame 7 and the front frame 7 comprises a front frame horizontal plate 71 and a front frame vertical plate 72.

The front frame horizontal plate 71 is a plate that is set in the front side of the backlight module and substantially parallel to the backplane 3. The front frame vertical plate 72 is a plate that is set in the area of the side frame of the backlight module. The front frame horizontal plate 71 and the front frame vertical plate 72 are perpendicular to each other.

After being assembled, the front frame horizontal plate 71 presses the liquid crystal glass 6 on the hold-down block 51 and the front frame vertical plate 72 is fastened on the outer side of the frame plate 52.

When the backlight module of the present invention is put into operation, since the light source 1 is directly fixed on the PCB 2 that has the bend and the PCB 2 is fixedly connected to the backplane 3, the heat generated by the light source 1 can be conducted away through the vertical plate 21 and the horizontal plate 22 of the PCB and the backplane 3 so as to achieve dissipation of head.

In other words, the backlight module of such a structure does not need to install heat dissipation device, such as an aluminum extrusion, inside the area of the side frame of the backlight module. This saves a step of assembling the PCB and the heat dissipation device and also saves material and also improves assembling efficiency and reduces the working costs.

Furthermore, the structure that dissipates heat through the PCB and the backplane can replace the heat dissipation structure constituted by aluminum extrusion so as to optimize a heat dissipation path within the module and effectively reduces the internal architecture of the backlight module to achieve the design of ultra-slim module side frame increase a viewing area.

In other embodiments of the backlight module according to the present invention, the plastic frame 5 can be structured to comprise only the hold-down block 51 but not the frame plate 52. The hold-down block 51 can be connected with the front frame vertical plate 72 of the front frame 7 to form a unitary body. In other words, the front frame vertical plate 72 is directly fastened on the outer side of the vertical plate 22 of the PCB. Thus, it is equivalent to the plastic frame 5 and the front frame 7 sharing one side frame plate so as to further slim the side frame of the backlight module.

The present invention also discloses a liquid crystal display device. The liquid crystal display device comprises the backlight module of any of the preceding embodiments. The specific way of practicing will not be repeated.

Practicing the backlight module of the present invention and the liquid crystal display device that uses the backlight module shows the following advantageous effects. Since the PCB of the backlight module forms a bend, heat generated by the light source can be conducted through the PCB that has the bend and the backplane so as to effect dissipation of heat. This saves a step of assembling the PCB and the heat dissipation device and also saves material and also improves assembling efficiency and reduces the working costs. The thermal path within the module can be optimized to effectively reduce the internal architecture of the backlight module to achieve the design of ultra-slim module side frame increase a viewing area.

The above disclosure only provides preferred embodiments of the present invention and is considered limiting to the scope of protection of the present invention. Thus, equivalent variations are considered within the scope of the present invention.

What is claimed is:

1. A backlight module, comprising a light source, a PCB and a backplane, wherein the PCB comprises a bend and the light source is fixed on the PCB that has the bend, the PCB being fixedly connected to the backplane to conduct away heat generated by the light source;
the PCB comprising a horizontal plate and a vertical plate perpendicularly connected to each other, the light source being set at an inner side of the vertical plate, the backplane being mounted at an inner side of the horizontal plate; and
the backlight module further comprising a plastic frame, the plastic frame mounted to the PCB that has the bend and an optical component of the backlight module to hold the optical component down on the backplane, the optical component at least comprising a diffusion plate, a prism, a diffusion plate, and a light guide plate.

2. The backlight module as claimed in claim 1, wherein the backlight module further comprises a front frame, the front frame comprising a front frame horizontal plate and a front frame vertical plate that are perpendicular to each other, the front frame horizontal plate pressing the liquid crystal glass against the plastic frame;
the front frame vertical plate being mounted at an outer side of the vertical plate of the PCB.

3. A backlight module, comprising a light source, a PCB and a backplane, wherein the PCB comprises a bend and the light source is fixed on the PCB that has the bend, the PCB being fixedly connected to the backplane to conduct away heat generated by the light source.

4. The backlight module as claimed in claim 3, wherein the PCB comprises a horizontal plate and a vertical plate perpendicularly connected to each other;
the light source being set at an inner side of the vertical plate, the backplane being mounted at an inner side or an outer side of the horizontal plate.

5. The backlight module as claimed in claim 3, wherein the backlight module further comprises a plastic frame, the plastic frame mounted to the PCB that has the bend and an optical component of the backlight module to hold the optical component down on the backplane.

6. The backlight module as claimed in claim 5, wherein the plastic frame comprises at least a hold-down block, the hold-down block having a side forming two pressing surfaces, of which one pressing surface presses down an end face of the vertical plate and the other pressing surface presses down an end portion of the optical component that is close to the light source.

7. The backlight module as claimed in claim 6, wherein the hold-down block has a side that is opposite to the side of the hold-down block that forms the pressing surfaces and is set to tightly engage the liquid crystal glass of the backlight module.

8. The backlight module as claimed in claim 6, wherein one end side of the hold-down block is bended to form a frame plate, the frame plate being mounted at an outer side of the vertical plate of the PCB.

9. The backlight module as claimed in claim 8, wherein the backlight module further comprises a front frame, the front frame comprising a front frame horizontal plate and a front frame vertical plate that are perpendicular to each other, the front frame horizontal plate pressing the liquid crystal glass against the plastic frame;
the front frame vertical plate being mounted at an outer side of the frame plate.

10. The backlight module as claimed in claim 6, wherein the backlight module further comprises a front frame, the front frame comprising a front frame horizontal plate and a front frame vertical plate that are perpendicular to each other, the front frame horizontal plate pressing the liquid crystal glass against the plastic frame;
the front frame vertical plate being mounted at an outer side of the vertical plate of the PCB.

11. The backlight module as claimed in claim 10, wherein the hold-down block and the front frame vertical plate are integrally formed together to form a unitary body.

12. A liquid crystal display device, the liquid crystal display device comprising a backlight module, wherein the backlight module comprises a light source, a PCB and a backplane, wherein the PCB comprises a bend and the light source is fixed on the PCB that has the bend, the PCB being fixedly connected to the backplane to conduct away heat generated by the light source.

13. The liquid crystal display device as claimed in claim 12, wherein the PCB comprises a horizontal plate and a vertical plate perpendicularly connected to each other;
the light source being set at an inner side of the vertical plate, the backplane being mounted at an inner side or an outer side of the horizontal plate.

14. The liquid crystal display device as claimed in claim 12, wherein the backlight module further comprises a plastic frame, the plastic frame mounted to the PCB that has the bend and an optical component of the backlight module to hold the optical component down on the backplane.

15. The liquid crystal display device as claimed in claim 14, wherein the plastic frame comprises at least a hold-down block, the hold-down block having a side forming two pressing surfaces, of which one pressing surface presses down an end face of the vertical plate and the other pressing surface presses down an end portion of the optical component that is close to the light source.

16. The liquid crystal display device as claimed in claim 15, wherein the hold-down block has a side that is opposite to the side of the hold-down block that forms the pressing surfaces and is set to tightly engage the liquid crystal glass of the backlight module.

17. The liquid crystal display device as claimed in claim 15, wherein one end side of the hold-down block is bended to form a frame plate, the frame plate being mounted at an outer side of the vertical plate of the PCB.

18. The liquid crystal display device as claimed in claim 17, wherein the backlight module further comprises a front frame, the front frame comprising a front frame horizontal plate and a front frame vertical plate that are perpendicular to each other, the front frame horizontal plate pressing the liquid crystal glass against the plastic frame;
the front frame vertical plate being mounted at an outer side of the frame plate.

19. The liquid crystal display device as claimed in claim 15, wherein the backlight module further comprises a front frame, the front frame comprising a front frame horizontal plate and a front frame vertical plate that are perpendicular to each other, the front frame horizontal plate pressing the liquid crystal glass against the plastic frame;
the front frame vertical plate being mounted at an outer side of the vertical plate of the PCB.

20. The liquid crystal display device as claimed in claim 19, wherein the hold-down block and the front frame vertical plate are integrally formed together to form a unitary body.
